(19) United States
(12) Patent Application Publication
(10) Pub. No.: US 2021/0180963 A1
(43) Pub. Date: Jun. 17, 2021

(54) ONBOARD DEVICE

(71) Applicant: DENSO CORPORATION, Kariya-city (JP)

(72) Inventor: Tomoo NOMURA, Kariya-city (JP)

(21) Appl. No.: 17/186,910

(22) Filed: Feb. 26, 2021

Related U.S. Application Data
(63) Continuation of application No. PCT/JP2019/033512, filed on Aug. 27, 2019.

(30) Foreign Application Priority Data
Aug. 31, 2018 (JP) 2018-163078

(51) Int. Cl. G01C 21/32; G07C 5/00; G01C 21/00; B60W 60/00

(52) U.S. Cl. CPC G01C 21/32; G07C 5/008; G01C 21/3819; B60W 2556/50; G01C 21/3889; G01C 21/3811; B60W 60/001; G01C 21/3841

(57) ABSTRACT

An onboard device includes a map data provision unit, a computation unit and a determination unit. The map data provision unit is configured to provide map data pertaining to a road on which a vehicle travels. The computation unit is configured to, when vehicle probe data indicating the positions and shapes of a road and a feature in the vicinity of the vehicle is given, compare the vehicle probe data with the map data provided from the map data provision unit to calculate a difference. The determination unit is configured to, when the difference exceeds a threshold value beyond which control of the vehicle based on the map data and the probe data will be impaired, determine the detected vehicle probe data as vehicle probe data to be transmitted.

### CROSS-REFERENCE TO RELATED APPLICATIONS

The present application is a continuation application of International Application No. PCT/JP2019/033512, filed on Aug. 27, 2019, which claims priority to Japanese Patent Application No. 2018-163078 filed on Aug. 31, 2018. The contents of these applications are incorporated herein by reference in their entirety.

### BACKGROUND

### 1. Technical Field

The present disclosure relates to an onboard device.

### 2. Related Art

There is an onboard device that is mounted on a vehicle, acquires information necessary for travel based on information on a vehicle and its surroundings and map data, and provides information for use in vehicle control. For example, in car navigation and autonomous driving, information necessary for travel is provided based on such information.

### SUMMARY

The present disclosure provides an onboard device. According to one aspect of the present disclosure, an onboard device includes a map data provision unit, a computation unit and a determination unit. The map data provision unit is configured to provide map data pertaining to a road on which a vehicle travels. The computation unit is configured to, when vehicle probe data indicating the positions and shapes of a road and a feature in the vicinity of the vehicle is given, compare the vehicle probe data with the map data provided from the map data provision unit to calculate a difference. The determination unit is configured to, when the difference exceeds a threshold value beyond which control of the vehicle based on the map data and the probe data will be impaired, determine the detected vehicle probe data as vehicle probe data to be transmitted.

### BRIEF DESCRIPTION OF THE DRAWINGS

In the accompanying drawings:

FIG. 1 is an electrical configuration diagram showing an embodiment;

FIG. 2 is a schematic configuration diagram of a system;

FIG. 3 is a diagram showing the flow of determination processing;

FIG. 4 is a diagram showing the flow of deterioration determination;

FIG. 5 is a diagram illustrating the calculation of a difference degree;

FIG. 6 is a diagram showing a specific example of the difference degree;

FIG. 7 is a diagram illustrating the calculation of a control margin;

FIG. 8 is a first diagram showing a specific example of the control margin;

FIG. 9 is a second diagram showing a specific example of the control margin;

FIG. 10 is a diagram illustrating the calculation of a landmark margin;

FIG. 11 is a first diagram showing a specific example of the landmark margin; and

FIG. 12 is a second diagram showing a specific example of the landmark margin.

### DETAILED DESCRIPTION OF THE PREFERRED EMBODIMENTS

An onboard device is mounted on a vehicle, acquires information necessary for travel based on information on a vehicle and its surroundings and map data, and provides information for use in vehicle control.

In this case, regarding the map data, in order to capture the actual situation, that actually changes from moment to moment, there has been considered a system designed to transmit the information recognized, for example, by a sensor provided in the vehicle to a center that manages map information in a centralized manner (hereinafter referred to as center) for updating purposes.

However, if all the information detected during travel of the vehicle is sent as probe data to the center, the amount of information increases. Therefore, the amount of communication increases, and a heavy burden of information analysis processing is imposed on the center side.

Therefore, there is a method of transmitting only necessary information as probe data, for example, as presented in JP 2007-264731 A. In this method, the vehicle needs to know the information which is not analyzed by the center. For this purpose, the latest map information is always transmitted to the onboard device from the center, and the onboard device finds differences between the latest map information and the information detected by the onboard device, and transmits the differences to the center.

By adopting this method, it is possible to reduce the amount of information as compared with the technique of transmitting all the information detected, during travel, by the vehicle as probe data to the center. However, assuming that the amount of information detected as probe data is further increased in order to improve the accuracy, there arises a problem of an increase in burden of information analysis processing on the center side.

An object of the present disclosure is to provide an onboard device capable of minimizing the amount of data, detected by a vehicle during travel, to be transmitted to a center, during travel, by a vehicle to a center to the minimum necessary to reduce the burden of information analysis processing at the center.

The inventor has considered the following points for the above purpose. First, conventionally, probe data is collected for the purpose of keeping map information updated, as described above. However, when the significance of this is further investigated, the final purpose is not to keep the map information updated, but is actually to realize the function using the map information. So, even if there is a difference in map information, whether the difference is information necessary for using the map information can be adopted as a new criterion to decide whether to upload the difference information as probe data.

In other words, even if there is a difference between the information held by the center that manages the map data and the situation in the real world, no practical problem will arise if functionality can be realized in the vehicle that uses the map data. Therefore, based on such a way of thinking, the difference information at a level that is unnecessary to realize the function is not uploaded to the center, so that the amount of information/communication of the data to be uploaded from the vehicle to the center can be further reduced.

In the above case, for example, when the vehicle is equipped with a robust control system, even if there is a slight difference between the map data and the actual situation, it is possible to handle the difference and perform proper control. In other words, even if there is a difference between the real world and the map information due to a certain change in the real world, it is possible to perform control correctly by virtue of the robustness of the control system.

Therefore, it can be decided that this difference between the real world and the map information does not affect the control, and the difference does not have to be transmitted to the center, and can be regarded as a difference that does not change the map information.

However, even if the difference between the real world and the map information does not affect the control as described above, if another difference at such a level occurs in another place close to the place, the control system may not work properly due to these two differences between the real world and the map information. In this case, only when control is not performed correctly, these differences are transmitted from the onboard device of the vehicle to the center so that the map information is changed.

That is, at the timing when the information for updating the map is transmitted from the onboard device to the center, a situation necessarily occurs in which control is not performed correctly, and the end user is disadvantaged.

In light of the above circumstances, an onboard device according to an aspect of the present disclosure includes:

a map data provision unit configured to provide map data pertaining to a road on which a vehicle travels;

a computation unit configured to, when vehicle probe data indicating the positions and shapes of a road and a feature in the vicinity of the vehicle is given, compare the vehicle probe data with the map data provided from the map data provision unit to calculate a difference; and

a determination unit configured to, when the difference exceeds a threshold value beyond which control of the vehicle based on the map data and the probe data will be impaired, determine the detected vehicle probe data as vehicle probe data to be transmitted.

The above configuration is adopted so that, even if there is a difference between the map data and the vehicle probe data regarding the recognized features, it is determined by the determination unit that the vehicle probe data does not have to be transmitted to update the map data when it falls within a controllable value range in which the travel of the vehicle can be controlled based on the map data and the vehicle probe data. Therefore, it is possible to reduce the amount of the vehicle probe data to be transmitted.

The above object and other objects, features and advantages of the present disclosure will be further clarified by the following detailed description with reference to the accompanying drawings.

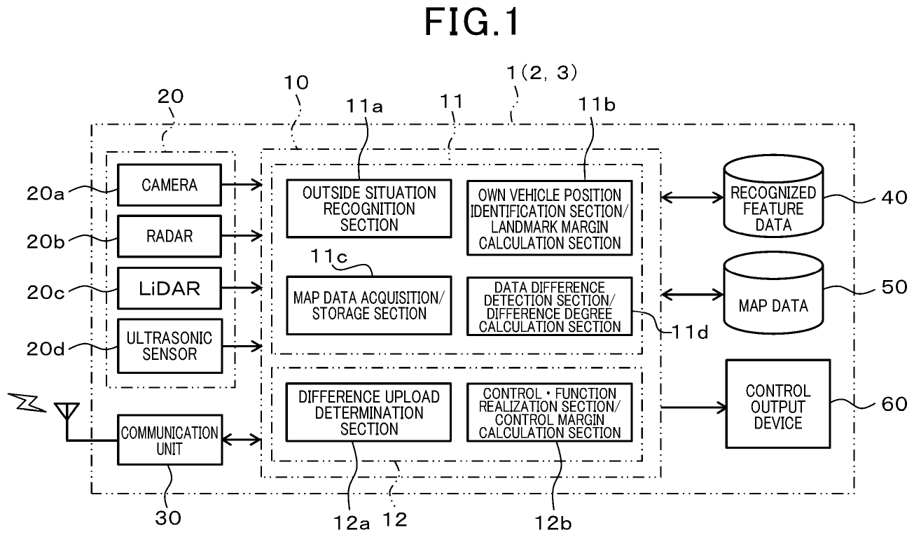

Hereinafter, an embodiment of the present disclosure will be described with reference to FIGS. 1 to 12.

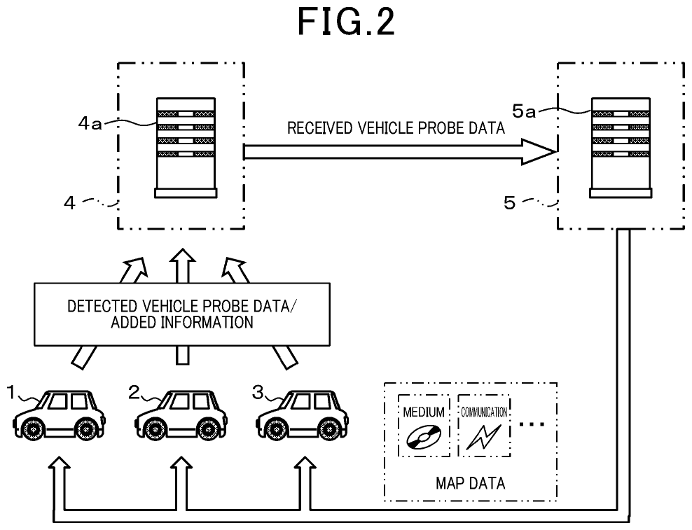

In FIG. 2 showing the overall configuration of this system, vehicles 1 to 3 travel on a road while collecting vehicle probe data as will be described below. The vehicles 1 to 3 are each provided with an autonomous driving system or driving support system, and perform driving control using the vehicle probe data and the map data.

The vehicles 1 to 3 each have a communication function, and transmit only vehicle probe data determined as vehicle probe data in which the map data needs to be updated in a manner as will be described below, among the detected vehicle probe data, to a server 4a of a map data collection center 4. The map data collection center 4 transmits the received vehicle probe data to a server 5a of a map data update center 5.

The map data update center 5 executes processing of updating the map data to map data corresponding to a latest situation based on the thus-transmitted vehicle probe data. The vehicles 1 to 3 acquire the latest map data updated and created at the map data update center 5 from a medium such as a DVD or by use of the communication function, and thus can obtain the latest map data.

Next, an onboard device 10 included in each of the vehicles 1 to 3 and the related configurations will be described with reference to FIG. 1. The onboard device 10 includes a computation unit 11 and a determination unit 12 as functional blocks. The computation unit 11 includes an outside situation recognition section 11a, an own vehicle position identification section/landmark margin calculation section 11b, a map data acquisition/storage section 11c, and a data difference detection section/difference degree calculation section 11d. The determination unit 12 includes a difference upload determination section 12a and a control⋅function realization section/control margin calculation section 12b. The onboard device 10 actually has a configuration mainly composed of a CPU, and achieves the functions of the computation unit 11 and the determination unit 12 based on programs stored therein.

Sensors 20 are connected to the onboard device 10. As the sensors 20, a camera 20a that captures the outside of the vehicle, a radar 20b, a LiDAR (Light Detection and Ranging/Laser Imaging Detection and Ranging) 20c, an ultrasonic sensor 20c, and the like are provided. When the sensor data detected by the sensors 20 are inputted to the onboard device 10, the computation unit 11 is used to analyze the data and calculate it as the vehicle probe data indicating the outside situation.

The camera 20a captures the front and surrounding situations outside the vehicle, and outputs the video information as sensor data. The radar 20b and LiDAR 20c detect the front and surrounding situations of the vehicle and distances from features, and output the information as the sensor data. The ultrasonic sensor 20d outputs ultrasonic waves to detect whether an object exists in vehicle surroundings, and outputs the information as the sensor data.

A communication unit 30 handles external communication for the onboard device 10, and communicates with the map data collection center 4 described above to transmit the vehicle probe data to be transmitted, which has been determined, in a manner as will be described later, by the onboard device 10. In addition, the communication unit 30 communicates with the map data update center 5 described above to download the updated latest map data or receive necessary map data each time.

A recognized feature data storage unit 40 stores the data on features recognized by the onboard device 10, which is read and used by the onboard device 10 as needed. A map data storage unit 50 stores and holds the latest map data downloaded from the server 5a of the map data update center 5 by the communication unit 30. With regard to the map data, map data stored in a medium such as a DVD may also be utilized, or the map data updated by the map data update center 5 may be sequentially downloaded and thus stored and held as the latest map data.

A control output device 60 is a control device for controlling travel of the vehicles 1 to 3, and controls the travel of the own vehicle in response to a travel control command created by the onboard device 10. In an autonomous driving/driving support mode, the onboard device 10 creates a travel control command based on the information captured by the sensor 20, and, in this case, refers to the map data as needed to realize highly accurate travel control.

<Outline of Autonomous Driving/Driving Support System>

Next, the outline of autonomous driving/driving support system in the vehicles 1 to 3 will be described. In this embodiment, the vehicles 1 to 3 are each equipped with an autonomous driving/driving support system. The role of the map data is an important element in the autonomous driving/driving support system. First, the autonomous driving/driving support system using the map data identifies the position of the own vehicle on the map data.

In this case, it is difficult to identify the position of a moving body on the earth, which is the absolute position thereof. GNSS (Global Navigation Satellite System) is generally used to identify the absolute position of a moving body, but, in that case, an error of about 10 m occurs. Therefore, there exists a technique of identifying the absolute position with higher accuracy, but which requires a large-scale device for measurement, so it is not realistic in terms of cost to install it in mass-produced vehicles.

Therefore, the onboard device 10 can adopt a technique of identifying the position including the above-described error, which has been captured from the communication unit 30 by GNSS, and then identifying where the own vehicle is located on the map data by using the map data with higher accuracy. Specifically, the position is identified by comparing the features on the map data with the surrounding information obtained from the sensor 20 and various other onboard sensors.

For example, the case is assumed where a state where a speed limit sign exists 10 m ahead of the own vehicle and that the own vehicle is traveling northward at a position 1.5 m away from the left outer line of the left lane is detected from the data obtained from onboard sensors. The own vehicle can acquire the map data on the surroundings of the own vehicle position estimated from the GNSS information, and calculate and identify where the own vehicle exists on the map data, from the shape of the road, i.e., lane and the positions of signs in the map data.

Next, control when the control⋅function of the own vehicle is realized in the autonomous driving/driving support system using the map data will be described. In some cases, it may not be possible to realize the control⋅function using only the surrounding information obtained from various onboard sensors, and the map data is used to deal with such cases.

For example, with regard to the function of traveling while keeping to the center of the lane, it is necessary to detect the front lane shape in advance for steering control, but, since there may be a blind corner in front, the front lane shape may not be recognized by the onboard sensors. In addition, it may be difficult for the onboard sensors to recognize the front lane shape due to weather conditions such as rain, snow or the like that make visibility poor. In such a case, the map data can be used to complement the recognition results of the onboard sensors, and the function of traveling while keeping to the center of the lane can be continued without interruption.

Next, the means of supplying the map data when the map data is utilized in the manner as described above will be described.

Any means of supplying the map data from the map data update center 5 to the onboard device 10 may be used, as described above, and such means can be classified as follows.

(1) The map data is captured and stored in the storage section 10c or the map data storage unit 50 of the onboard device 10 via a medium such as a CD or DVD flash memory. Alternatively, the map data in the medium may be read the onboard device 10, as needed, in a state where the medium is attached to the device.

(2) The map data is captured and stored in the storage section 10c within the onboard device 10 or the map data storage unit 50 via a cellular communication network, Wi-Fi, Bluetooth (registered trademark) and the like, using the communication unit 30.

In this case, either the map data on the whole country or only the map data on the surroundings of the location where the onboard devices 10 of the vehicles 1 to 3 exist may be stored as the map data held in the onboard device 10 or the map data storage unit 50.

Further, the storage section 10c and the map data storage unit 50 may store the map data semi-permanently to reuse it, or may adopt a method of making a request to the map data update center 5 each time of use to obtain and use it.

In this embodiment, it is assumed that the amount of communication between the onboard device 10 and the map data collection center 4 is reduced to the minimum necessary, and thus the map data used, as data for comparison, by the onboard device 10 is desirably as fresh as possible. Therefore, it is preferable that the latest map data should always be acquired by the communication unit 30 using a wide area communication network or the like and used as data for comparison. This is because the permanent use of old map data as data for comparison tends to increase the gap between the map data and the outside situation as the real world, and does not match the purpose of suppressing the amount of communication of the vehicle probe data to be uploaded.

<Description of Operation of Onboard Device 10>

Next, the operation of the onboard device 10 will be described.

The target to be recognized by the onboard device 10 as the situation in the real world, i.e., the outside situation, based on the sensor data detected by the sensor 20 is as follows. This is vehicle probe data required for vehicle control, and it is determined whether to transmit it to the map data collection center 4 as needed.

The target to be recognized includes road lane markings, pedestrian crossings, stop lines, channelizing strips, regulation arrows, and other markings drawn on the road surface such as information for use in traffic control and traffic regulation drawn on the road. In addition, targets provided as objects are, for example, signs for regulation, warning, guidance and assistance, traffic lights, and other objects which can serve as landmarks used by the onboard device to identify its own position.

Further the computation unit 11 of the onboard device 20 calculates the positions, forms, meanings, and the like of the targets described above, including, in the case of road lane markings, the three-dimensional positions of the markings and their colors such as white or yellow; and, in the case of signs, the three-dimensional positions of the signs themselves, the heights/widths of the signs, the three-dimensional positions of the support columns of the signs, the types of the signs, and the meanings of the signs.

As the sensors 20 that recognize the outside information, the camera 20a, the radar 20b, the LiDAR 20c, the ultrasonic sensor 20d, and the like are provided. It is not necessary to provide all of these sensors, and they can also be selectively provided. By combining the sensor data detected by these sensors 20, GNSS information, and other vehicle information such as speed, the outside situation can be recognized.

<Map Data Processing>

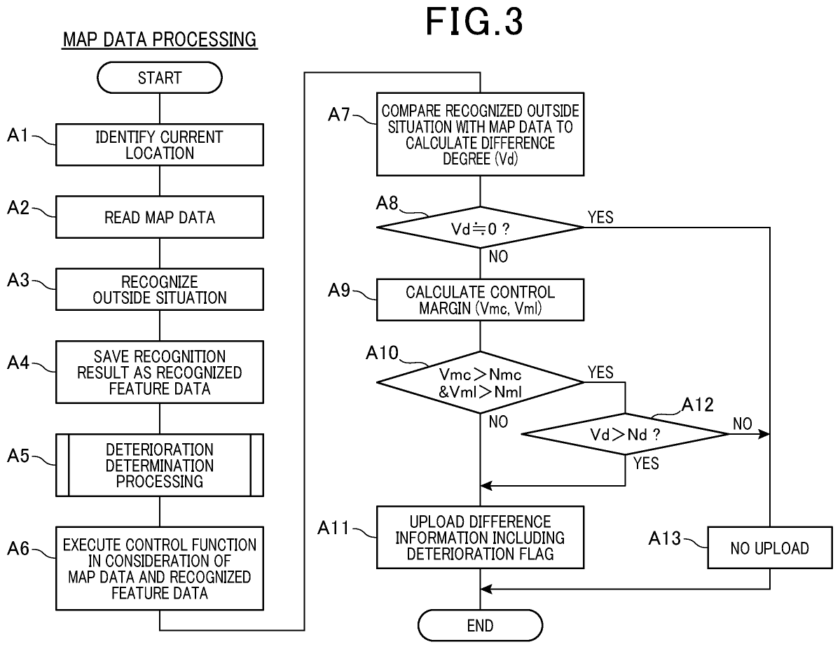

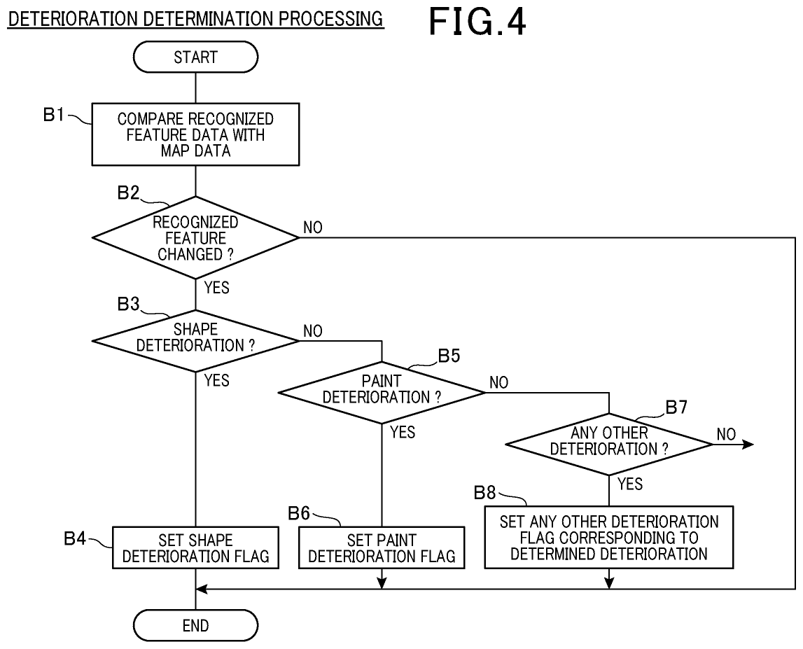

Next, the contents of the map data processing by the onboard device 10 will be described with reference to FIGS. 3 and 4. In the following description, the contents of the map data processing will be described, as a whole, as being executed by the onboard device 10, but, in terms of function, are operations shared by the computation unit 11 and the determination unit 12. Furthermore, it is assumed that the onboard device 10 is controlling autonomous driving of the vehicle 1.

First, the onboard device 10 identifies the current position in step A1. The onboard device 10 computes and identifies the current position by the own vehicle position identification section/landmark margin calculation section 11b based on the GNSS information received via the communication unit 30. In this step, the approximate position of the own vehicle on the map is acquired. Next, the onboard device 10 reads the map data from the map data storage unit 50 in step A2. In this step, the onboard device 10 reads the map data on a region around the current position identified in step A1 from the map data storage unit 50 by the map data acquisition/storage section 11c.

Subsequently, the onboard device 10 performs outside situation recognition processing in step A3. In this step, the onboard device 10 first captures data regarding the outside situation, for example, from the camera 20a, radar 20b, LiDAR 20c and ultrasonic sensor 20d constituting the sensors 20, sensors mounted in other vehicles, and the like by the outside situation recognition section 11a.

After that, the onboard device 10 recognizes lane markings, pedestrian crossings, stop lines, channelizing strips and regulation arrows drawn with as markings on the road surface, other information for use in traffic control and traffic regulation drawn on the road, and the like, in the outside situation recognition section 11a, and also recognizes signs and traffic lights provided as objects and other landmarks used by the onboard device to identify its own position. After that, the onboard device 10 saves the recognized feature data recognized by the outside situation recognition section 11a in the recognized feature data storage unit 40, in step A4.

Next, the onboard device 10 performs deterioration determination processing in step A5. In this case, the deterioration information obtained by this processing is determined so that the data detected as the difference between the recognized feature data and the map data is intentionally not uploaded to the map data collection center 4, or is transmitted in a state in which a “deterioration flag” is added thereto when it is uploaded.

For example, when it is decided, through recognition by the onboard device 10, that a change is not a change intended by a road manager, like a change when a marking on the road, such as a painted lane marking, has been rubbed off and has disappeared due to deterioration or when a sign has been bent and changed in position, the change is determined as such deterioration information.

In this case, faintness or disappearance, due to deterioration, of the marking drawn on the road is determined by comparison in terms of the value of recognition confidence degree when the onboard device 10 recognizes the lane marking on the road and the lane marking position on the map data.

When the lane marking exists on the map data, and the recognition result by the onboard device 10 leads to a reduction in lane marking recognition confidence degree below the threshold value, so that the onboard device 10 determines that the lane cannot be detected, and, as a result, concludes that a difference between the map data and the outside situation has occurred, the onboard device 10 decides that the difference is due to “paint deterioration”, and adds a “deterioration flag” when the difference is recorded as the difference information.

The map data update center 5 sets the threshold value at the time of changing the data on the difference information added with the “deterioration flag” to be higher than those for other changes. This is because, even if the lane marking has become faint and has disappeared and thus cannot be seen in reality, the onboard device 10 determines that the lane marking should originally have existed there, and leaves the data on the map data, so that it may be able to be utilized in the control by the onboard device 10.

The specific contents of the deterioration determination processing are performed by the outside situation recognition section 11a through the procedures shown in FIG. 4. In step B1, the onboard device 10 compares the recognized feature data with the map data. Based on this comparison result, the onboard device 10 decides, in step B2, whether any recognized feature has been changed, and, in the case of “NO”, terminates the processing with no change determination.

In the case of “YES” in step B2, the onboard device 10 decides, in the next step B3, whether the change state is due to shape deterioration such as when a sign has been bent and changed in position. In the case of “YES”, it sets the “deterioration flag” for shape deterioration. In the case of “NO” in step B3, the onboard device 10 proceeds to step B4. In step B4, the onboard device 10 decides whether the change state is due to paint deterioration such as when the marking on the road has been rubbed off or has disappeared due to deterioration, and, in the case of “YES”, sets the “deterioration flag” for paint deterioration.

When deciding, in step B2, that a change has occurred, which is not due to shape deterioration or paint deterioration, the onboard device 10 determines, in step B7, whether the change is due to any other deterioration. In the case of “YES”, the onboard device 10 proceeds to step B8, and sets “deterioration flag” corresponding to the determined deterioration. In the case of “NO” in step B7, the onboard device 10 decides that the change is intentional and not due to deterioration. As a result, the onboard device 10 terminates the deterioration determination processing and proceeds to the next step A6, determining that step A5 in FIG. 3 is completed.

In step A6, the onboard device 10 executes the function of controlling the autonomous driving by the control⋅function realization section/control margin calculation section 12b of the determination unit 12, in consideration of the map data and the recognized feature data obtained in the manner described above, and outputs the control to the control output device 60.

At this time, in step A7, first, the onboard device 10 compares the recognized outside situation with the map data to calculate a difference degree Vd, in the data difference detection section/difference degree calculation section 11d of the computation unit 11.

Here, the data difference detection section/difference degree calculation section 11d of the onboard device 10 calculates, as the difference degree Vd, information obtained by quantizing a degree of difference between the real-world situation recognized in the manner described above and the stored map data.

In this case, the data difference detection section/difference degree calculation section 11d specifically calculates the difference degree Vd for each type of outside situation detected in a range in which the vehicle travels a certain distance, i.e., a determination range. The determination level for the difference degree Vd is set to differ depending on type. For example, the determination level for the sign position is set to less than 75%, and, specifically, when a positional discrepancy is found in one of four signs, the difference degree Vd is acceptable. The determination level for the stop line is set to 100%, and if a positional discrepancy is found even in one stop line, the difference information is uploaded. The determination level for the difference degree Vd is determined based on how the map data is used in the onboard device 10.

The reason why the determination level for the sign position is low is as follows. Specifically, the sign position is utilized for identifying the position of the own vehicle in the map data, and the processing is not performed based on one sign, but comprehensive processing/determination is performed based on a plurality of sign positions.

On the other hand, when the stop line position is utilized to identify the position of the own vehicle, the front/rear position determination can be processed very clearly. Therefore, the positional difference of one stop line may greatly affect the position identification of the onboard device 10. Also, in vehicle control, when stopping the vehicle at a stop line, positional deviation of the stop line may cause problems when there is uncertainty in processing performed by the onboard device 10, for example, when the onboard device 10 has difficulty in recognizing the outside due to bad weather or when the outside situation cannot be seen due to the preceding vehicle or the like.

Next, the onboard device 10 decides, in step A8, whether the calculated value of the difference degree Vd can be regarded as substantially zero in consideration of error. In the case of “NO”, i.e., when the difference degree Vd cannot be regarded as zero, the onboard device 10 proceeds to step A9 and calculates a control margin Vmc and a landmark margin Vml.

The control margin, as used herein, is an index indicating the margin when the onboard device 10 performs vehicle control. The onboard device 10 feeds back the results of vehicle control using the outside situation and the map data, for the purpose of quantification as to whether the vehicle was controlled with a sufficient margin, or in other words, whether control was impaired.

The onboard device 10 compares the result of control performed in consideration of the outside situation with the result of vehicle control assumed based on the information read from the map data in advance, when performing the vehicle control. Actually, the outside situation will be used preferentially. For example, in the case of the function of traveling while keeping to the center of the lane, possible contents to be compared are the amount of deviation of the vehicle from the center of the lane, the lateral acceleration of the vehicle, and the like. The onboard device 10 compares these numerical values, and decides that the control margin is large when each difference is small.

In the case of “YES” in step A8, the onboard device 10 performs step A13 and terminates the processing. In step A13, the onboard device 10 decides not to upload the information to the map data collection center 4 because the difference degree Vd as the target for determination can be regarded as substantially zero.

Next, when proceeding to step A10, the onboard device 10 determines whether the control margin Vmc is larger than a predetermined threshold Nmc and the landmark margin Vml is larger than a predetermined threshold Nml. The onboard device 10 proceeds to step A11 in the case of “NO” in step A10, that is, when both the control margin Vmc and the landmark margin Vml are equal to or less than the threshold values.

In the above case, the onboard device 10 determines both the control margin Vmc and the landmark margin Vml during vehicle control. Further, when not performing vehicle control, it determines only the landmark margin Vml. As a result, it can perform a determination including the conditions for the contents of the actually-performed control, and, even when not performing vehicle control, can perform a determination intended for this.

In step A11, the onboard device 10 performs processing of uploading the difference information calculated based on the sensor data as the vehicle probe data including the deterioration flag described above. As a result, the onboard device 10 transmits the vehicle probe data to the server 4a of the map data collection center 4 via the communication unit 30.

On the other hand, in the case of “YES” in step A10 described above, i.e., when both the control margin Vmc and the landmark margin Vml are sufficiently larger than the threshold values, the onboard device 10 proceeds to step A12 in which it decides whether the difference degree Vd exceeds a predetermined threshold value Nd. When the difference Vd exceeds a certain amount though the control margin is sufficient, the onboard device 10 determines “YES”, proceeds to step A11, and performs processing of uploading the information as vehicle probe data. In the case of “NO” in step A12, the onboard device 10 performs step A13 and terminates the processing.

By virtue of execution of the map data processing described above, the amount of communication can be reduced by omitting uploading of the vehicle probe data to the data collection center 4 if the vehicle control by the onboard device 10 can be performed without any trouble, even if the detected vehicle probe data has some difference from the map data.

<Calculation of Difference Degree>

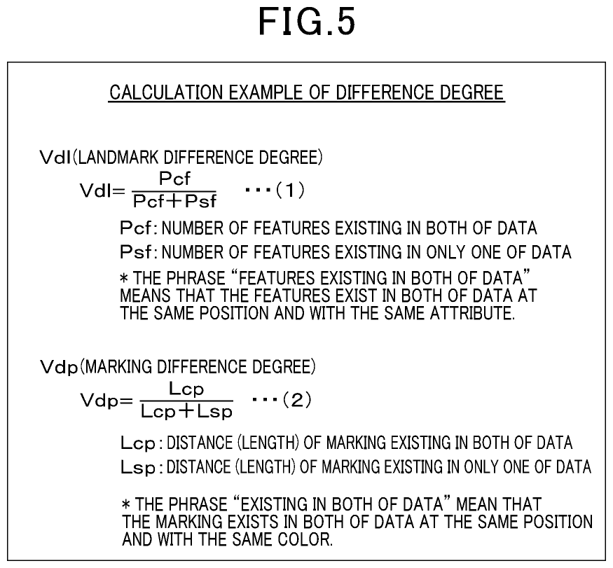

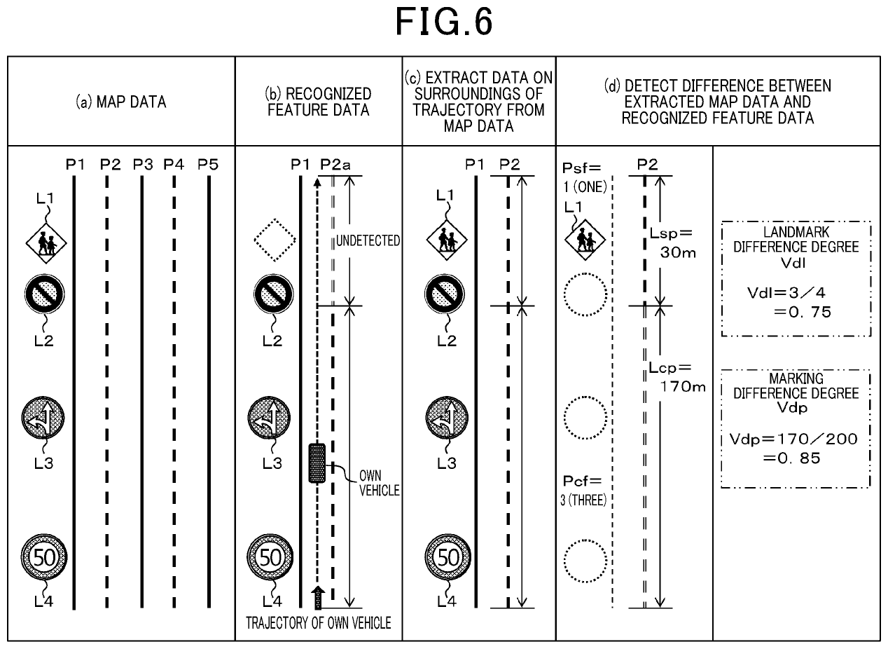

Next, calculation examples of the difference degree Vd described above will be described with reference to FIGS. 5 and 6. The difference degree Vd is set for each type. For example, the difference degree regarding landmarks, i.e., features is Vdl, and the difference degree regarding markings is Vdp. Now, calculation examples of these difference degrees will be described.

The landmark difference Vdl is calculated as shown by equation (1) in FIG. 5. For the quantification processing, the number of features, i.e., landmarks, existing in both the recognized feature data and the map data is defined as Pcf, and the number of features existing in only one of these data is defined as Psf. Further, the phrase “features existing in both of these data” means that the features exist in both of these data at the same position and with the same attribute.

Next, the marking difference degree Vdp is calculated as shown by equation (2) in FIG. 5. For the quantification processing, the distance (length) of a marking existing in both the recognized feature data and the map data is defined as Lcp, and the distance (length) of a marking existing in only one of them is defined as Lsp. Further, the phrase “existing in both of these data” means that the marking exists in both of these data at the same position and with the same color.

FIG. 6 shows a specific example. FIG. 6(a) shows map data acquired, for example, by downloading on the vehicle side. Markings P1 to P5 that separate the lanes and four signs L1 to L4 are shown.

On the other hand, FIG. 6(b) shows feature data recognized by the onboard device 10, for example, by means of the sensor 20. The own vehicle travels on a track indicated by a broken line with an arrow, and there are markings P1 and P2 and three signs L2 to L4 as features existing around the trajectory. Among these, the marking P2 is a lane marking of the lane adjacent to the lane on the own vehicle travels, which is shown as a marking P2a in which an undetected portion exists in front.

FIG. 6(c) shows the result of extracting the data on the surroundings of the trajectory of the own vehicle shown in FIG. 6 (b) from the map data. In this figure, the markings P1 and P2 and four signs L1 to L4 are extracted.

When the difference Vd is calculated by executing the processing shown in step A7 of the processing shown in FIG. 3 described above, the result as shown in FIG. 6(d) is obtained. Difference data is shown in the left column. In this figure, the sign L1 existing only in the map data is shown, and the other signs L2 to L4 exist in both of the map data and the recognized feature data, and thus are not displayed as differences. With regard to the markings, there is a difference in the marking P2, and an undetected portion in the recognized feature data is displayed as a difference.

From this result, the landmark difference degree Vdl can be calculated according to equation (1) as follows:

$$Vdl = Pcf / ( Pcf + Psf ) = 3 / 4 = 0.7 \; 5 ,$$

since the number of features Pcf existing in both of these data is 3, and the number of features Psf existing only in one of these data is 1.

Further, the marking difference degree Vdp can be calculated according to equation (2) as follows:

$$Vdp = Lcp / ( Lcp + Lsp ) = 17 \; 0 / 2 \; 00 = 0.8 \; 5 ,$$

since the distance Lcp of the marking existing in both of these data is 170 m, and the distance Lsp of the marking existing only in one of these data is 30 m.

<Calculation of Control Margin>

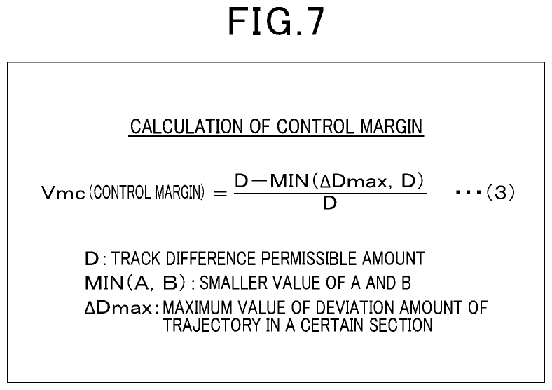

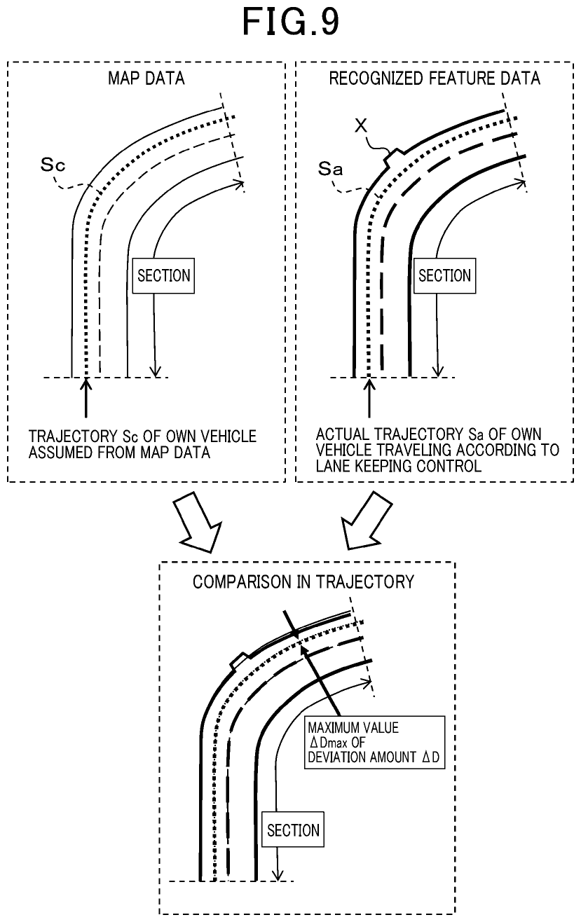

Next, a calculation example of the control margin Vcm described above will be described with reference to FIGS. 7 and 9. The control margin Vcm is obtained by quantifying the difference between the trajectory estimated from the map data and the locus of travel according to the actual vehicle control. The control margin Vcm is calculated as shown by equation (3) in FIG. 7.

For the quantification processing, here, the track difference permissible amount in a certain section is defined as D; the deviation amount of the travel track in the certain section from the estimated track is defined as AD; and the maximum value in the section is defined as ΔD max. Further, an operator MIN (A, B) shall take a smaller value of the numbers A and B in parentheses.

When the actual travel control is performed, the control margin in the traveled section is calculated according to the above definition. As a result, as shown by equation (3), when the maximum value ΔD max of the deviation amount exceeds the track difference permissible amount D, the margin Vcm becomes zero, and when the maximum value ΔD max is equal to or less than the track difference permissible amount D, the margin Vcm is obtained as a value larger than zero.

That is, when the onboard device 10 performs vehicle control based on the map data and the recognized feature data, the margin Vcm may be obtained as a value larger than zero even if there is a difference between these data. In this case, the onboard device 10 is able to perform vehicle control with a margin even if there is no updated map data corresponding to the difference degree, and it can be understood to be unnecessary to transmit the vehicle probe data having such a difference degree to the map data collection center 4.

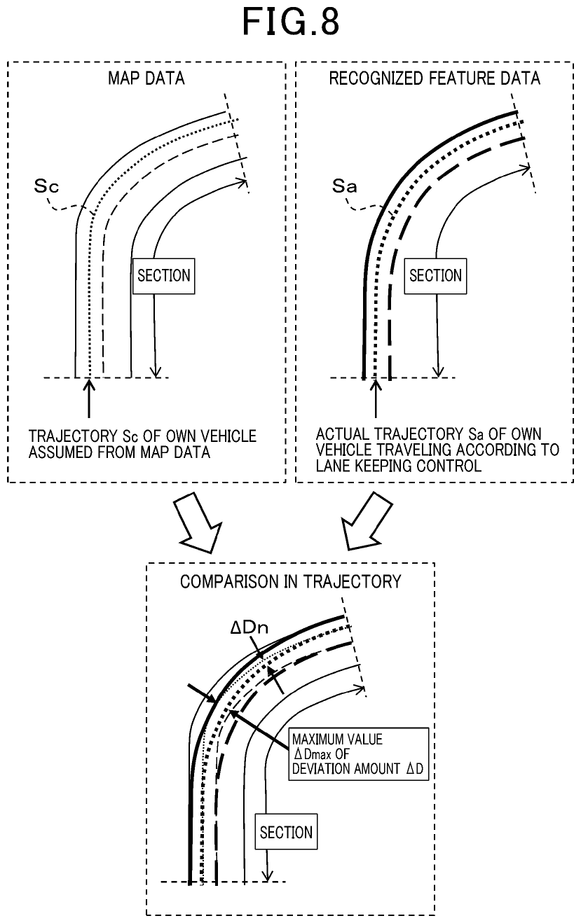

FIGS. 8 and 9 show specific examples 1 and 2. In FIG. 8 showing specific example 1, the map data regarding the road acquired by downloading or the like on the vehicle side is shown at the upper left, and the trajectory Sc of the own vehicle estimated from the map data is shown by the dotted line in the figure. On the other hand, FIG. 8 shows, at the upper right, the feature data regarding the road recognized by the onboard device 10, for example, via the sensor 20. The curve shape of the recognized road is gentler than the curve shape in the map data. The actual trajectory Sa of the own vehicle traveling according to the lane keeping control from the lane marking indicating the travel lane is shown in the figure.

On the lower side of FIG. 8, the map data and the recognized feature data are shown in a superimposed state, in order to compare the trajectory Sc estimated from the map data in a certain section with the actual trajectory Sa of the own vehicle. In the figure, a plurality of the deviation amounts ΔD between the estimated trajectory Sc and the actual trajectory Sa of the own vehicle (ΔD1 to ΔDn) within the section are calculated, and the largest deviation amount, among these, is shown as ΔD max. Based on the thus-obtained results, the control margin Vcm1 can be calculated according to the above equation (3).

In this case, the control margin Vcm1 is calculated as follows. For example, when the maximum value ΔD max of the detected deviation amount ΔD is 0.3 m and the track difference permissible value D here is 0.1 m, the control margin Vcm in the section is calculated from equation (3) as follows.

$$Vmc 1 = ( 0.1 - MIN ( 0.3 , 0.1 ) ) / 0.1 = 0$$

In FIG. 9 showing specific example 2, the same map data as that shown in FIG. 8 is shown at the upper left, and the trajectory Sc of the own vehicle estimated from the map data is shown by the dotted line in the figure. On the other hand, FIG. 9 shows, at the upper right, the feature data regarding the road recognized by the onboard device 10, for example, via the sensor 20. The recognized road is provided with an evacuation region X on the outer side of the curve. The actual trajectory Sa of the own vehicle traveling according to the lane keeping control from the lane marking indicating the travel lane is shown in the figure.

On the lower side of FIG. 9, the map data and the recognized feature data are shown in a superimposed state, in order to compare the trajectory Sc estimated from the map data in a certain section with the actual trajectory Sa of the own vehicle. In the figure, a plurality of the deviation amounts ΔD between the estimated trajectory Sc and the actual trajectory Sa of the own vehicle (ΔD1 to ΔDn) within the section are similarly calculated, and the largest deviation amount, among these, is shown as ΔD max.

In this case, the control margin Vcm2 is calculated as follows. For example, when the maximum value ΔD max of the detected deviation amount ΔD is 0.02 m and the track difference permissible value D here is 0.1 m, the control margin Vcm2 in the section is calculated from equation (3) as follows.

$$Vcm 2 = ( 0.1 - MIN ( 0.02 , 0.1 ) ) / 0.1 = 0.8$$

<Calculation of Landmark Margin>

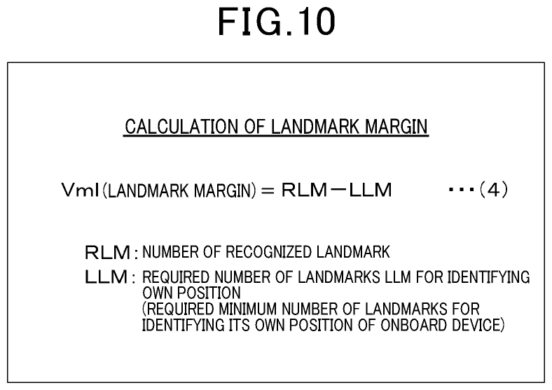

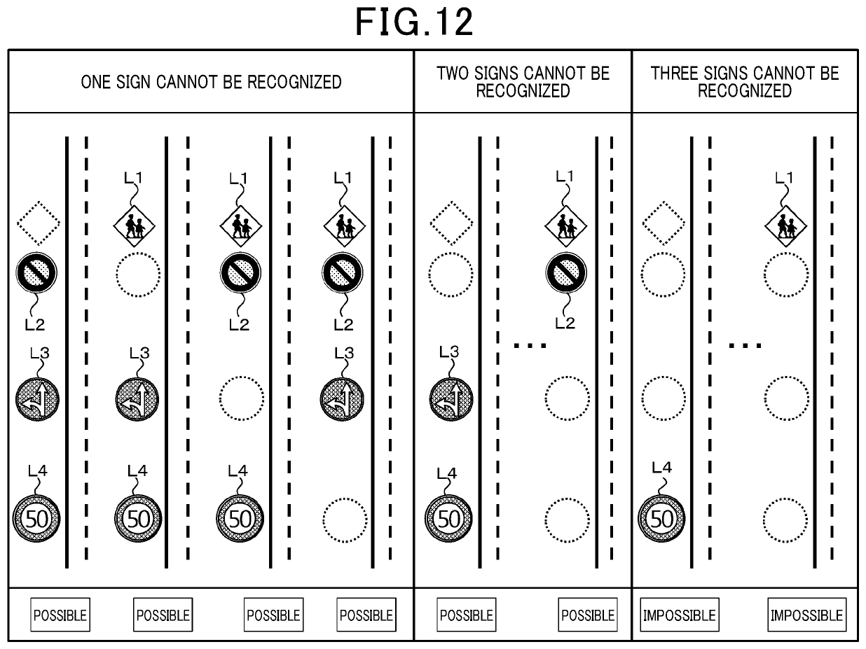

Next, a calculation example of the landmark margin Vml will be described with reference to FIGS. 10 and 12. The difference between the feature data read from the map data by the onboard device 10 and the actual recognized feature data can be detected regardless of whether during the travel control by the onboard device 10 or not.

In this case, when identifying the vehicle position on the map, the onboard device 10 recognizes a plurality of landmarks, i.e., signs to match the recognition result to the map data, and thus is usually designed to have robustness as the control function so as to be able to identify the own vehicle position even if there is some deviation. However, it is intended, on purpose, to virtually confirm and evaluate whether the position of the own vehicle could be identified properly when the landmarks recognized by the onboard device 10 could be used or recognized.

On the assumption of a state in which the number of landmarks are virtually decreased, it is estimated whether the onboard device 10 can identify its own position to determine a required number of landmarks LLM for identifying its own position. As shown by equation (4) in FIG. 10, the difference between the number of landmarks RLM properly recognized at present and the required number of landmarks LLM is the landmark margin Vml.

Since different map data are referred to and recognized for the control margin Vmc and the landmark margin Vml, the amount of communication can be suppressed by uploading only the relevant difference information when the vehicle probe data is uploaded as difference information to the map data collection center 4 through the margin determination. Therefore, for example, when the control margin Vmc is larger than the threshold value but the landmark margin Vml is smaller than or equal to the threshold value, only the vehicle probe data indicating the difference information relevant to landmarks is uploaded to the map data collection center 4.

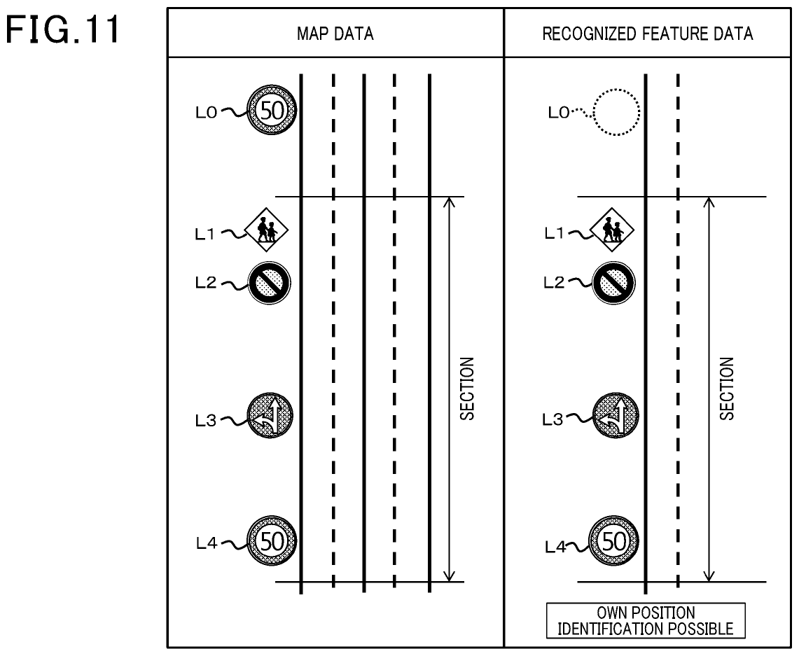

Examples of calculating the landmark margin Vml will be described with reference to FIGS. 11 and 12. On the left side of FIG. 11, signs L0 to L4 are shown on a four-lane road as landmarks indicated in the map data. On the other hand, on the right side of FIG. 11, a travel lane and signs L1 to L4 are shown as landmarks indicated in the data regarding the features recognized in a section.

In this case, the data regarding the features recognized in the section are the four signs L1 to L4, which match the signs L1 to L4 in the map data, and the position can be identified by the onboard device 10. The landmark margin Vml is calculated in this situation.

It is assumed that there is little recognized feature data as to whether the position can be identified by the onboard device 10. As described above, the number of recognized landmarks RLM is 4. As shown in FIG. 12, assuming that one feature data cannot be recognized, there are four cases as shown in the figure, and the onboard device 10 can identify the position in all of these cases. Similarly, assuming that two feature data cannot be recognized, two cases are shown FIG. 12, but there are six cases. The onboard device 10 can also identify the position in all of these cases.

In contrast, two cases in which three feature data cannot be recognized are shown FIG. 12, but there are four cases, and the onboard device 10 cannot identify the position in these cases. Thus, in these cases, the required number of landmarks LLM for identifying its own position of the onboard device 10 in the section is 2.

As a result, the landmark margin Vml can be obtained according to equation (4) shown in FIG. 10 as follows.

$$Vml = 4 - 2 = 2$$

According to this embodiment as described above, the computation unit 11 and the determination unit 12 are provided in the onboard device 10, and, even if there is a difference between the map data and the vehicle probe data regarding the recognized features, it is determined by the determination unit 12 that the vehicle probe data does not have to be transmitted to update the map data when it falls within a controllable value range in which the travel of the vehicle can be controlled based on the map data and the vehicle probe data. Therefore, it is possible to reduce the amount of the vehicle probe data to be transmitted.

### Other Embodiments

It should be noted that the present disclosure is not limited to the above embodiment, and can be applied to various embodiments without departing from the gist thereof. For example, the present disclosure can be modified or extended as follows.

While the present disclosure has been described with reference to an embodiment, it is to be understood that the disclosure is not limited to the embodiment and structure. The present disclosure covers various modification and equivalent arrangements. In addition, while the various combinations and configurations, other combinations and configurations, including more, less or only a single element, are also within the spirit and scope of the present disclosure.

What is claimed is:

1. An onboard device that determines whether vehicle probe data is to be transmitted to a transmitting target, the onboard device comprising:
a map data provision unit configured to provide map data pertaining to a road on which a vehicle travels;
a computation unit configured to, when the vehicle probe data indicating the positions and shapes of a road and a feature in the vicinity of the vehicle is given, compare the vehicle probe data with the map data provided from the map data provision unit to calculate a difference; and
a determination unit configured to, when the difference falls within a permissible range in which the travel of the vehicle can be controlled based on the map data and the vehicle probe data, determine that the given vehicle probe data is not to be transmitted.

2. The onboard device according to claim 1, wherein the determination unit calculates, according to the difference, a control margin when the travel of the vehicle is controlled based on the map data and the probe data, and determines the given vehicle probe data as the vehicle probe data to be transmitted when the calculated control margin is smaller than a first threshold value.

3. The onboard device according to claim 1, wherein the computation unit calculates a difference degree according to an amount of difference between the vehicle probe data and the map data in terms of the positions or shapes of the road and feature indicated thereby, and the determination unit determines, as the vehicle probe data to be transmitted, the given vehicle probe data under the condition that the difference degree exceeds a second threshold value.

4. The onboard device according to claim 3, wherein the determination unit calculates, according to the difference, a control margin when the travel of the vehicle is controlled based on the map data and the probe data, and determines, as the vehicle probe data to be transmitted, the given vehicle probe data under the conditions that the calculated control margin is smaller than a first threshold value and that the difference degree exceeds the second threshold value.

5. The onboard device according to claim 2, wherein the determination unit employs different determination conditions for calculation of the control margin, between when the travel of the vehicle is controlled and when the travel of the vehicle is not controlled, based on the map data and the vehicle probe data.

6. The onboard device according to claim 4, wherein the determination unit employs different determination conditions for calculation of the control margin, between when the travel of the vehicle is controlled and when the travel of the vehicle is not controlled, based on the map data and the vehicle probe data.

7. The onboard device according to claim 2, wherein the computation unit detects, as a deterioration degree, a degree of the difference when the positions or shapes of the road and feature in the vehicle probe data detected by a sensor are changed, relative to those in the map data, by deterioration, and the determination unit adds data on the deterioration degree to the vehicle probe data to be transmitted, when determining that the deterioration degree as the vehicle probe data to be transmitted.

8. The onboard device according to claim 3, wherein the computation unit detects, as a deterioration degree, a degree of the difference when the positions or shapes of the road and feature in the vehicle probe data detected by a sensor are changed, relative to those in the map data, by deterioration, and the determination unit adds data on the deterioration degree to the vehicle probe data to be transmitted, when determining that the deterioration degree as the vehicle probe data to be transmitted.

9. The onboard device according to claim 2, further comprising a communication device that transmits the vehicle probe data to be transmitted, which has been determined by the determination unit, to a map data collection center.

10. The onboard device according to claim 3, further comprising a communication device that transmits the vehicle probe data to be transmitted, which has been determined by the determination unit, to a map data collection center.

11. The onboard device according to claim 1, further comprising a sensor that detects the vehicle probe data indicating positions or shapes of a road and a feature in the vicinity of the vehicle.

12. A method implemented by at least one processor for determining whether vehicle probe data is to be transmitted to a transmitting target, the method comprising:
providing map data pertaining to a road on which a vehicle travels;
comparing the vehicle probe data with the provided map data to calculate a difference, when the vehicle probe data indicating the positions and shapes of a road and a feature in the vicinity of the vehicle is given; and
determining that the given vehicle probe data is not to be transmitted, when the difference falls within a permissible range in which the travel of the vehicle can be controlled based on the map data and the vehicle probe data.
